(19) United States
(12) Patent Application Publication
(10) Pub. No.: US 2013/0154722 A1
(43) Pub. Date: Jun. 20, 2013

(54) VOLTAGE-STABILIZING CIRCUIT

(71) Applicant: HAI-QING ZHOU, Shenzhen City (CN)

(72) Inventor: HAI-QING ZHOU, Shenzhen City (CN)

(73) Assignees: Hon Hai Precision Industry Co., Ltd., Tu-Cheng (TW); Hong Fu Jin Precision Industry (ShenZhen) Co., Ltd, Shenzhen City (CN)

(21) Appl. No.: 13/457,940

(22) Filed: Apr. 27, 2012

(30) Foreign Application Priority Data
Dec. 19, 2011 (CN) 201110426569.0

(51) Int. Cl. G05F 1/10

(52) U.S. Cl. 327/540

(57) ABSTRACT

A voltage-stabilizing circuit includes a comparator and an RC circuit. A positive input of the comparator receives an enable signal. A negative input of the comparator receives a reference voltage. The RC circuit includes a first resistor and a capacitor. A first terminal of the capacitor is connected to an output of the comparator, a second terminal of the capacitor is grounded through a first resistor, and the first terminal of the capacitor is further connected to an enable pin of a power integrated circuit.

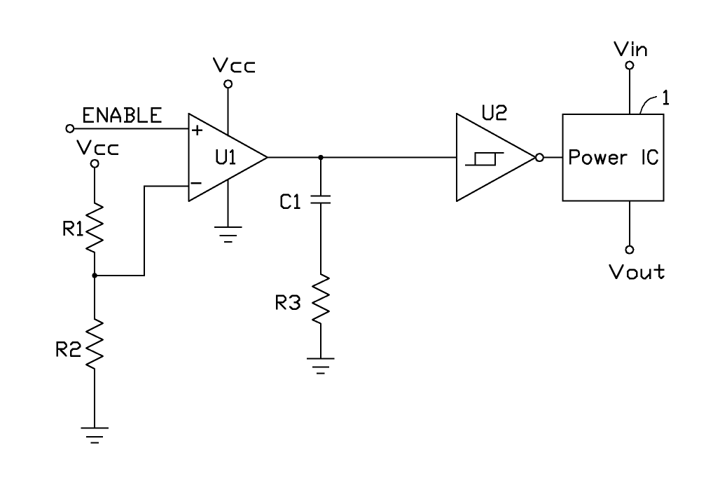

### BACKGROUND

1. Technical Field

The present disclosure relates to a circuit for stabilizing voltage output from an electronic device.

2. Description of Related Art

When a voltage received by the enable pin of a power integrated circuit (IC) is greater than a threshold voltage, the power IC outputs a voltage. If the voltage received by the enable pin is not stable, problems with the power IC may occur. Therefore, there is room for improvement in the art.

### BRIEF DESCRIPTION OF THE DRAWING

Many aspects of the embodiments can be better understood with reference to the following drawings. The components in the drawing are not necessarily drawn to scale, the emphasis instead being placed upon clearly illustrating the principles of the present embodiments. Moreover, in the drawing, like reference numerals designate corresponding parts throughout the view.

The FIGURE is a circuit diagram of an exemplary embodiment of a stabilizing circuit.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the FIGURE, an exemplary embodiment of a voltage-stabilizing circuit for stabilizing an output voltage of a power integrated circuit (IC) 1, includes a comparator U1, a Schmitt trigger U2, three resistors R1, R2, and R3, and a capacitor C1. The voltage-stabilizing circuit is connected to an enable pin of the power IC 1.

A power supply Vcc is grounded through the resistors R1 and R2 connected in series. The resistors R1 and R2 form a voltage divider circuit.

A positive input of the comparator U1 receives an enable signal ENABLE. A negative input of the comparator U1 is connected to a node between the resistors R1 and R2. A power terminal of the comparator U1 is connected to the power supply Vcc. A ground terminal of comparator U1 is grounded. An output of the comparator U1 is grounded through the capacitor C1 and the resistor R3 connected in series. The output of the comparator U1 is further connected to an input of the trigger U2. An output of the trigger U2 is connected to the enable pin of the power IC 1.

In the embodiment, resistances of the resistors R1 and R2 are set to make a voltage on the node between the resistors R1 and R2 to be greater than a minimum voltage of the enable signal ENABLE and less than a maximum voltage of the enable signal ENABLE. As a result, during a period when the enable signal ENABLE is not stable, the comparator U1 outputs a low level signal and a high level signal alternately. The resistor R3 and the capacitor C1 form an RC circuit.

When an electronic device including the voltage-stabilizing circuit and the power IC 1 is powered on, the voltage of the enable signal ENABLE is unstable. The voltage outputted from the comparator U1 charges up the RC circuit and is not inputted to the trigger U2. After a delay time (defined by the RC circuit), the output voltage from the comparator U1 is inputted to the trigger U2. In the embodiment, the delay time is set to be equal to a period during which the enable signal ENABLE is unstable.

After the delay time, when the enable signal ENABLE becomes stable, the voltage of the enable signal ENABLE is greater than the voltage on the node between the resistors R1 and R2. The high level signal from the comparator U1 is transmitted to the trigger U2. The trigger U2 smoothes the high level signal and then transmits the high level signal to the enable pin of the power IC 1.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A voltage-stabilizing circuit comprising:
a comparator comprising a positive input receiving an enable signal and a negative input received a reference voltage; and
a RC circuit comprising a first resistor and a capacitor, wherein a first terminal of the capacitor is connected to an output of the comparator, a second terminal of the capacitor is grounded through the first resistor, the first terminal of the capacitor is further connected to an enable pin of a power integrated circuit (IC).

2. The voltage-stabilizing circuit of claim 1, wherein the reference voltage is provided by a voltage divider circuit, the voltage divider circuit comprises a second resistor, a third resistor, and a power supply, the power supply is grounded through the second resistor and the third resistor connected in series, a node between the second resistor and the third resistor is connected to the negative input of the comparator.

3. The voltage-stabilizing circuit of claim 1, further comprising a Schmitt trigger connected between the first terminal of the capacitor and the enable pin of the power IC.

4. The voltage-stabilizing circuit of claim 1, wherein a delay time of the RC circuit is set to be equal to a period when the enable signal is not stable.
